(19) United States
(12) Patent Application Publication
(10) Pub. No.: US 2026/0031749 A1
(43) Pub. Date: Jan. 29, 2026

(54) FASTENING TOOL

(71) Applicant: MAKITA CORPORATION, Anjo-shi (JP)

(72) Inventors: Toshihito YABUNAKA, Anjo-shi (JP); Hiroki IKUTA, Anjo-shi (JP)

(73) Assignee: MAKITA CORPORATION, Anjo-shi (JP)

(21) Appl. No.: 19/263,755

(22) Filed: Jul. 9, 2025

(30) Foreign Application Priority Data
Jul. 23, 2024 (JP) 2024-117702

(51) Int. Cl. H02P 3/22; B21J 15/10; B21J 15/26; B21J 15/28; B21J 15/32; H02P 25/03; H02P 27/08

(52) U.S. Cl. CPC H02P 3/22; B21J 15/105; B21J 15/26; B21J 15/285; B21J 15/32; H02P 25/03; H02P 27/08

(57) ABSTRACT

A fastening tool includes: a pin gripping part; a first detecting device configured to detect that the pin gripping part is located in a first detection position; a first abutment part configured to move integrally with the pin gripping part; a second abutment part provided within the tool body and configured to position the pin gripping part in the frontmost position by abutting on the first abutment part; a second detecting device configured to detect abutment between the first abutment part and the second abutment part; and a control device configured to control driving of the motor. The control device decelerates the motor when the first detecting device detects that the pin gripping part reaches the first detection position in the process of moving forward, and thereafter stops the motor when the second detecting device detects abutment between the first abutment part and the second abutment part.

### CROSS-REFERENCE TO RELATED APPLICATION

The present application claims priority to Japanese patent application No. 2024-117702 filed on Jul. 23, 2024. The contents of the foregoing applications are hereby fully incorporated herein by reference.

### TECHNICAL FIELD

The present disclosure relates to a fastening tool that is configured to fasten workpieces by using a fastener.

### BACKGROUND

A known fastening tool is configured to fasten workpieces by moving a pin gripping part gripping a pin of a fastener, rearward from a prescribed position and thus deforming the fastener and to thereafter return the pin gripping part to the prescribed position by moving the pin gripping part forward. A position of the pin gripping part in an initial state (which is referred to as an initial position or a home position) is desirably set such that the pin gripping part can grip the pin with appropriate force. For example, in a fastening tool disclosed in United States Patent Application Publication No. 2024/0066587, a controller decelerates a motor when a fastener gripping part (pin gripping part) reaches within a prescribed distance from a prescribed home position in a reset process of the fastener gripping part. Thereafter, when a Hall sensor detects that the fastener gripping part reaches the prescribed home position, the controller stops the motor.

### SUMMARY

In the above-described fastening tool, the motor is decelerated before the Hall sensor detects that the fastener gripping part reaches the home position, so that deviation between the home position and an actual stop position of the fastener gripping part can be reduced. The sensitivity of the Hall sensor however varies due to temperature, individual differences or other factors, which may cause variation in the actual stop position of the fastener gripping part.

Accordingly, it is a non-limiting object of the present disclosure to provide a technique that helps to improve the positioning accuracy of the pin gripping part in the initial state of the fastening tool.

In one non-limiting aspect according to the present disclosure, a fastening tool is provided that is configured to fasten workpieces by using a fastener having a pin and a cylindrical part. The fastening tool includes a tool body, a motor, a pin gripping part, a first detecting device, a first abutment part, a second abutment part, a second detecting device and a control device.

The motor is housed in the tool body. The pin gripping part is configured to grip the pin. The pin gripping part is operably connected to the motor and configured to be moved relative to the tool body between a frontmost position and a rearmost position along a driving axis that defines a front-rear direction of the fastening tool, by power of the motor. The first detecting device is configured to detect that the pin gripping part is located in a first detection position between the frontmost position and the rearmost position in the front-rear direction.

The first abutment part is configured to move integrally with the pin gripping part relative to the tool body in the front-rear direction. The second abutment part is provided within the tool body and configured to position the pin gripping part in the frontmost position by abutting on the first abutment part when the pin gripping part is moved forward to the frontmost position. The first abutment part may be a part of the pin gripping part, or may be a part of a separate member connected to the pin gripping part. Similarly, the second abutment part may be a part of the tool body, or may be a part of a separate member connected to the tool body. The second detecting device is configured to detect abutment between the first abutment part and the second abutment part.

The control device is configured to control driving of the motor. The pin gripping part is configured to fasten the workpieces via the fastener by moving rearward from the frontmost position. The control device is configured to decelerate the motor when the first detecting device detects that the pin gripping part reaches the first detection position in a process of moving forward, and to thereafter stop the motor when the second detecting device detects abutment between the first abutment part and the second abutment part. The control device can be embodied, for example, by at least one processor/processing circuit.

In the fastening tool according to this aspect, when the pin gripping part is moved forward back to the frontmost position after fastening operation is performed while the pin gripping part is moved rearward, the first abutment part and the second abutment part abut each other, and the pin gripping part is positioned in the frontmost position, and the control device stops the motor. Thus, the motor is stopped while the pin gripping part is physically prevented from moving forward in the frontmost position. Therefore, the pin gripping part is reliably returned to the frontmost position. In the process of the forward movement of the pin gripping part, the control device decelerates the motor when the first detecting device detects that the pin gripping part reaches the first detection position rearward of the frontmost position. Thus, impact in collision between the first abutment part and the second abutment part is effectively reduced or suppressed.

It is preferable that the control device reduces the rotational speed of the motor to be a prescribed speed suitable for reliably suppressing impact at least at the time of abutment between the first abutment part and the second abutment part. For example, the control device may continue to decelerate the motor until the first abutment part and the second abutment part abut each other during the forward movement from the first detection position, such that the rotational speed of the motor reaches a prescribed speed or lower at the time of abutment between the first abutment part and the second abutment part. Alternatively, the control device may complete the deceleration before the first abutment part and the second abutment part abut each other.

### BRIEF DESCRIPTION OF THE DRAWINGS

FIG. 1 is a sectional view of a fastening tool.

FIG. 2 is a partial, enlarged view of FIG. 1 (not showing a fastener).

FIG. 3 is another partial, enlarged view of FIG. 1.

FIG. 4 is a sectional view taken along line IV-IV in FIG. 3, in an initial state where the motor is stopped

FIG. 5 is a sectional view taken along line V-V in FIG. 3.

FIG. 6 is a sectional view corresponding to FIG. 4, showing a state where a pin gripping part has reached a frontmost position from the rear.

FIG. 7 is a sectional view corresponding to FIG. 3, showing a state where the pin gripping part has reached a first detection position.

FIG. 8 is a sectional view corresponding to FIG. 4, showing the state where the pin gripping part has reached the first detection position.

FIG. 9 is a sectional view corresponding to FIG. 3, showing a state where the pin gripping part has reached a deceleration completion position.

FIG. 10 is a sectional view corresponding to FIG. 4, showing the state where the pin gripping part has reached the deceleration completion position.

FIG. 11 is a block diagram showing the electrical structure of the fastening tool.

FIG. 12 is a flow chart of a first control processing in pulling operation of the pin gripping part.

FIG. 13 is an explanatory view showing change of the rotational speed and the driving current of the motor in a fastening process.

FIG. 14 is a flow chart of a second control processing in return operation of the pin gripping part.

FIG. 15 is a flow chart of a first control processing according to a second embodiment of the present disclosure.

### DETAILED DESCRIPTION OF THE EMBODIMENTS

In one non-limiting embodiment according to the present disclosure, the control device may be configured to reduce the rotational speed of the motor to a prescribed speed when the first detecting device detects that the pin gripping part reaches the first detection position, and to thereafter drive the motor at the prescribed speed until the second detecting device detects abutment between the first abutment part and the second abutment part. According to this embodiment, the rotational speed of the motor can be reduced to be a suitable speed for reliably suppressing impact at the time of abutment between the first abutment part and the second abutment part.

In addition or in the alternative to the preceding embodiment, the second detecting device may be configured to detect a physical quantity relating to a driving state of the motor. The driving state of the motor changes when the pin gripping part is physically prevented from moving forward from the frontmost position by abutment between the first abutment part and the second abutment part. Therefore, abutment between the first abutment part and the second abutment part is rationally detected by detecting the physical quantity relating to the driving state of the motor.

In addition or in the alternative to the preceding embodiments, the second detecting device may be configured to detect at least one of (i) a current value of the motor, (ii) change of the current value of the motor, (iii) rotational speed of the motor, and (iv) change of the rotational speed, as the physical quantity. When the pin gripping part is physically prevented from moving forward from the frontmost position by abutment between the first abutment part and the second abutment part, the motor is stopped and load on the motor is rapidly increased. Therefore, abutment between the first abutment part and the second abutment part is properly detected by using at least one of the above-described physical quantities (i) to (iv).

In addition or in the alternative to the preceding embodiments, the first detecting device may be a magnetic sensor. According to this embodiment, the pin gripping part located in the first detection position is detected with a simple mechanism.

In addition or in the alternative to the preceding embodiments, the motor may be a three-phase brushless motor. The control device may be configured to generate a braking force by short-circuiting terminals of at least two phases of the motor to decelerate the motor. According to this embodiment, the magnitude of the braking force can be properly adjusted by changing the number of the phases to be short-circuited and/or the short-circuiting time.

In addition or in the alternative to the preceding embodiments, the control device may be configured to decelerate the motor by changing a duty ratio for PWM control of the motor. According to this embodiment, the motor is properly decelerated by simple control.

In addition or in the alternative to the preceding embodiments, the rotational speed of the motor after deceleration may be lower than 20% of the rotational speed before deceleration. According to this embodiment, impact in collision between the first abutment part and the second abutment part is reduced or suppressed, while the rotational speed before deceleration is set relatively high in consideration of the efficiency of the fastening operation.

In addition or in the alternative to the preceding embodiments, the rotational speed after deceleration may be set such that stress due to abutment between the first abutment part and the second abutment part does not exceed fatigue limits of the first abutment part and the second abutment part. According to this embodiment, the possibility of damage of the first and second abutment parts is effectively reduced.

In addition or in the alternative to the preceding embodiments, the fastening tool may further include a screw feeding mechanism that is operably connected to the motor and the pin gripping part. The screw feeding mechanism may include a nut member and a shaft member. The nut member may be supported to be rotatable around the driving axis within the tool body, and configured to be rotationally driven by the power of the motor. The shaft member may be operably engaged with the nut member so as to move integrally with the pin gripping part linearly in the front-rear direction when the nut member is rotated. The shaft member may have a rotation stopping part that is configured to inhibit rotation of the shaft member around the driving axis by engaging with the tool body. A part of the rotation stopping part may be configured as the first abutment part. According to this embodiment, the first abutment part is rationally provided by utilizing the rotation stopping part that is necessary for the screw feeding mechanism provided to drive the pin gripping part.

In addition or in the alternative to the preceding embodiments, the fastening tool may further include a reaction force receiving part that is arranged between the nut member and the first abutment part in the front-rear direction and configured to receive rearward reaction force applied to the nut member when the shaft member is moved forward. A part of the reaction force receiving part may be configured as the second abutment part. According to this embodiment, the second abutment part is rationally provided by utilizing the reaction force receiving part of the nut member.

In addition or in the alternative to the preceding embodiments, the fastening tool may further include a third detecting device, a third abutment part and a fourth abutment part. The third detecting device may be configured to detect that the pin gripping part is located in a second detection position between the first detection position and the rearmost position in the front-rear direction. Like the first detecting device, the third detecting device may be a magnetic sensor.

The third abutment part may be configured to move integrally with the pin gripping part relative to the tool body in the front-rear direction. The fourth abutment part may be provided within the tool body and configured to position the pin gripping part in the rearmost position by abutting on the third abutment part when the pin gripping part is moved rearward to the rearmost position. The third abutment part may be a part of the pin gripping part, or may be a part of a separate member connected to the pin gripping part. Similarly, the fourth abutment part may be a part of the tool body, or may be a part of a separate member connected to the tool body. The second detecting device may be further configured to detect abutment between the third abutment part and the fourth abutment part.

The control device may be configured to decelerate the motor when the third detecting device detects that the pin gripping part reaches the second detection position in a process of moving rearward, and to thereafter stop rotation of the motor when the second detecting device detects abutment between the third abutment part and the fourth abutment part.

According to this embodiment, even when the pin gripping part is moved rearward, the fastening tool operates similarly as when the pin gripping part is moved forward. Specifically, the fastening operation is performed while the pin gripping part is moved rearward, and when the pin gripping part reaches the rearmost position, the third abutment part and the fourth abutment part abut each other, and the pin gripping part is positioned in the rearmost position, and the control device stops the motor. Thus, the motor is stopped while the pin gripping part is physically prevented from moving in the rearmost position. Therefore, the pin gripping part is reliably positioned in the rearmost position. Further, in the process of the rearward movement of the pin gripping part, the control device decelerates the motor when the third detecting device detects that the pin gripping part reaches the second detection position forward of the rearmost position. Thus, impact in collision between the third abutment part and the fourth abutment part is effectively reduced or suppressed. A decelerating method in the process of the rearward movement of the pin gripping part may be substantially the same as or different from the above-described decelerating method in the process of the forward movement of the pin gripping part.

Representative and non-limiting embodiments of the present disclosure are now described in detail with reference to the attached drawings.

### First Embodiment

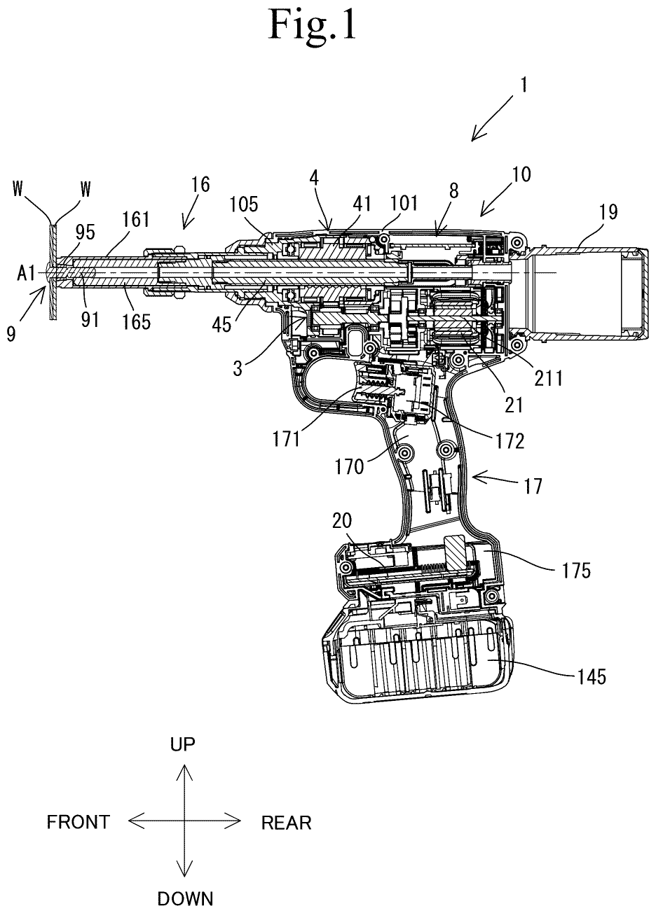

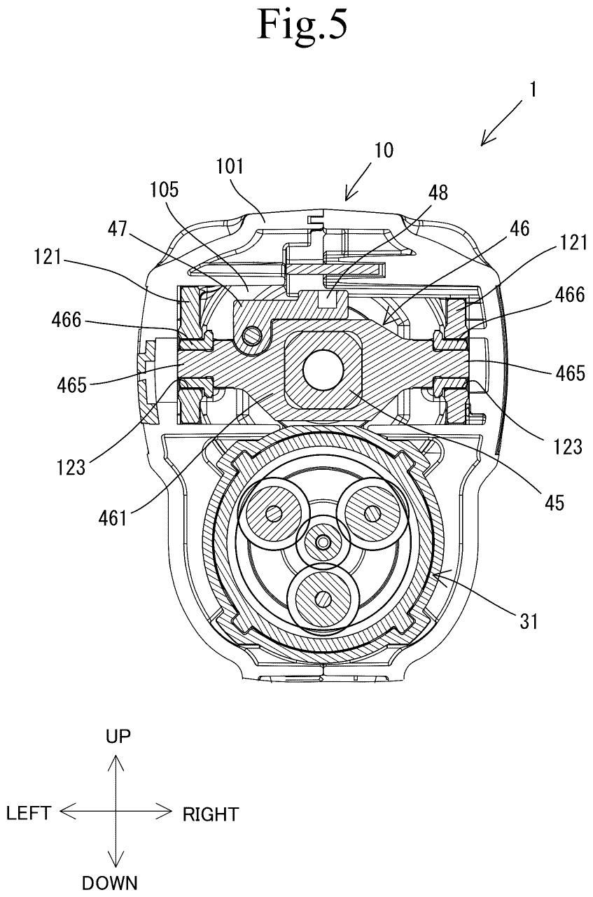

A fastening tool 1 according to a first embodiment of the present disclosure is described with FIGS. 1 to 14. The fastening tool 1 is an example of a power tool that is configured to fasten workpieces by using a fastener.

Plural kinds of fasteners can be selectively used with the fastening tool 1. A fastener 9 shown in FIG. 1 is an example of the fastener that can be used with the fastening tool 1. More specifically, the fastener 9 is an example of a known fastener that is called a multi-piece swage type fastener.

The structure of the fastener 9 is now described in brief. The fastener 9 includes a pin 91 and a collar 95. The pin 91 has a shaft part and a head that is integrally formed on an end of the shaft part. The collar 95 is a cylindrical member through which the shaft part can be inserted. The pin 91 and the collar 95 are formed separately. When the pin 91 is pulled in an axial direction relative to the collar 95 by the fastening tool 1, the collar 95 is deformed and swaged onto the shaft part of the pin 91, so that workpieces W are fastened by the head of the pin 91 and the swaged collar 85.

The brief structure of the fastening tool 1 is now described.

As shown in FIG. 1, the fastening tool 1 has a tool body 10, a nose 16 and a handle 17.

The tool body 10 is a hollow body and is also referred to as a housing. The tool body 10 houses a motor 21 and a driving mechanism 3. The nose 16 includes a cylindrical anvil 161 and a pin gripping part 165 that is arranged within the anvil 161. The anvil 161 is fixedly connected to one end part of the tool body 10 so as to extend along a prescribed driving axis A1. The pin gripping part 165 is operably connected to the driving mechanism 3 and can be moved along the driving axis A1 relative to the anvil 161. A collecting container 19 is removably attached to an end part of the tool body 10 on the side opposite to the anvil 161 in an extending direction of the driving axis A1 and configured to collect a pintail that is separated in a fastening process.

The handle 17 has an elongate cylindrical shape and is configured to be held by a user. The handle 17 extends in a cantilever form in a direction crossing the driving axis A1 (specifically, in a direction substantially orthogonal to the driving axis A1) from the tool body 10. A trigger 171 is provided in the handle 17 and configured to be depressed by a user. A battery 145 is removably mounted on a free end of the handle 17. The fastening tool 1 is operated by power supplied from the battery 145.

In the following description, as for the direction of the fastening tool 1, the extending direction of the driving axis A1 is defined as a front-rear direction of the fastening tool 1. In the front-rear direction, the side on which the nose 16 is arranged is defined as a front side and the opposite side (on which the collecting container 19 is arranged) is defined as a rear side. Further, a direction orthogonal to the driving axis A1 and corresponding to a longitudinal direction of the handle 17 is defined as an up-down direction. In the up-down direction, one end side of the handle 17 that is connected to the tool body 10 is defined as an upper side, and the opposite side (the free end side of the handle 17) is defined as a lower side. A direction orthogonal to the front-rear direction and the up-down direction is defined as a left-right direction.

When a user engages part of the shaft part of the pin 91 of the fastener 8 with a front end opening of the anvil 161 and depresses the trigger 171, the motor 21 is driven. The driving mechanism 3 is then driven by power of the motor 21 and the pin gripping part 165 grips the pin 91 and strongly pulls the pin 91 rearward relative to the collar 95, so that the fastener 9 is deformed and the workpieces W are fastened. A part (pintail) of the shaft part of the pin 91 is torn off and separated from the fastener 9. Subsequently, the pin gripping part 165 is returned forward by the driving mechanism 3, and a series of operations of a fastening process is completed. The rearward moving operation and the forward moving operation of the pin gripping part 165 are also referred to as a pulling operation and a return operation, respectively.

The physical structure of the fastening tool 1 is now described in detail.

First, the tool body 10 and elements disposed therein are described.

As shown in FIG. 1, the tool body 10 has an outer housing 101 and an inner housing 105. The outer housing 101 has a generally rectangular box-like shape and extends along the driving axis A1. The inner housing 105 has a generally cylindrical shape and is fixedly held within an upper front half part of the outer housing 101 by the outer housing 101. In this embodiment, the outer housing 101 is formed of resin integrally with the handle 17, and the inner housing 105 is formed of metal.

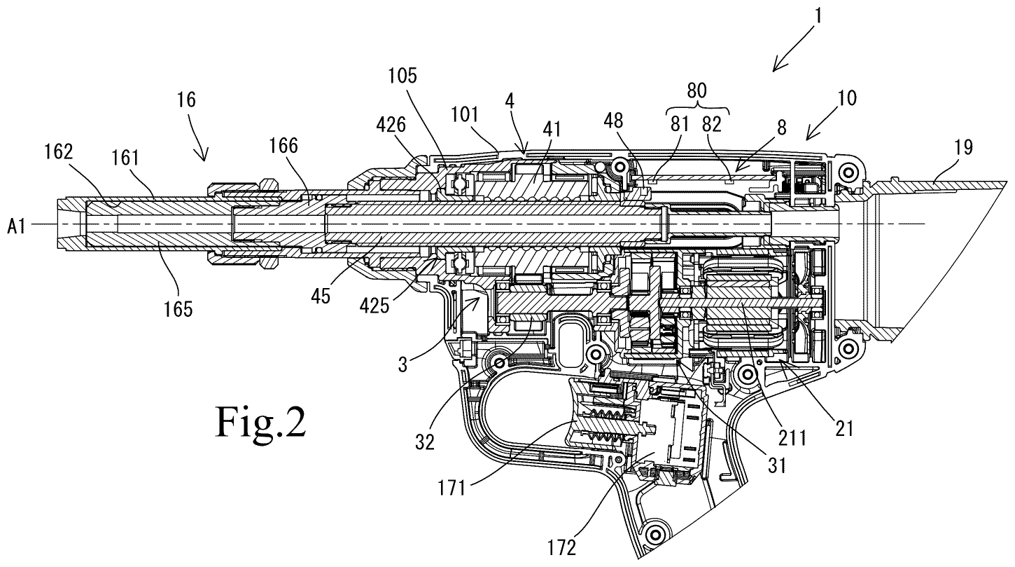

As shown in FIG. 2, the tool body 10 mainly houses the motor 21, the driving mechanism 3 and a position detecting mechanism 8.

The motor 21 is housed in a lower rear end part of the tool body 10. In this embodiment, a three-phase brushless DC motor is used as the motor 21. A rotational axis of a motor shaft 211 extends in parallel to the driving axis A1 (i.e. in the front-rear direction) below the driving axis A1. The motor shaft 211 can rotate in two directions of a normal direction and a reverse direction. The normal direction corresponds to a direction of moving a screw shaft 45 (described below) and the pin gripping part 165 rearward, and the reverse direction corresponds to a direction of moving the screw shaft 45 and the pin gripping part 165 forward.

The driving mechanism 3 is operably connected to the motor 21. The driving mechanism 3 is configured to move the pin 91 of the fastener 9 in the front-rear direction relative to the collar 95 by power of the motor 21. More specifically, the driving mechanism 3 is configured to move the pin gripping part 165 gripping the pin 91, along the driving axis A1 relative to the tool body 10 and the anvil 161.

The driving mechanism 3 of this embodiment includes a planetary reduction gear (planetary gear reducer) 31, a driving gear 32 and a ball screw mechanism 4.

The planetary reduction gear 31 is arranged coaxially with the motor 21 in front of the motor 21 within a lower half part of the tool body 10. The driving gear 32 is arranged coaxially with the planetary reduction gear 31 in front of the planetary reduction gear 31. The planetary reduction gear 31 is configured to increase torque inputted from the motor shaft 211 and rotate the driving gear 32.

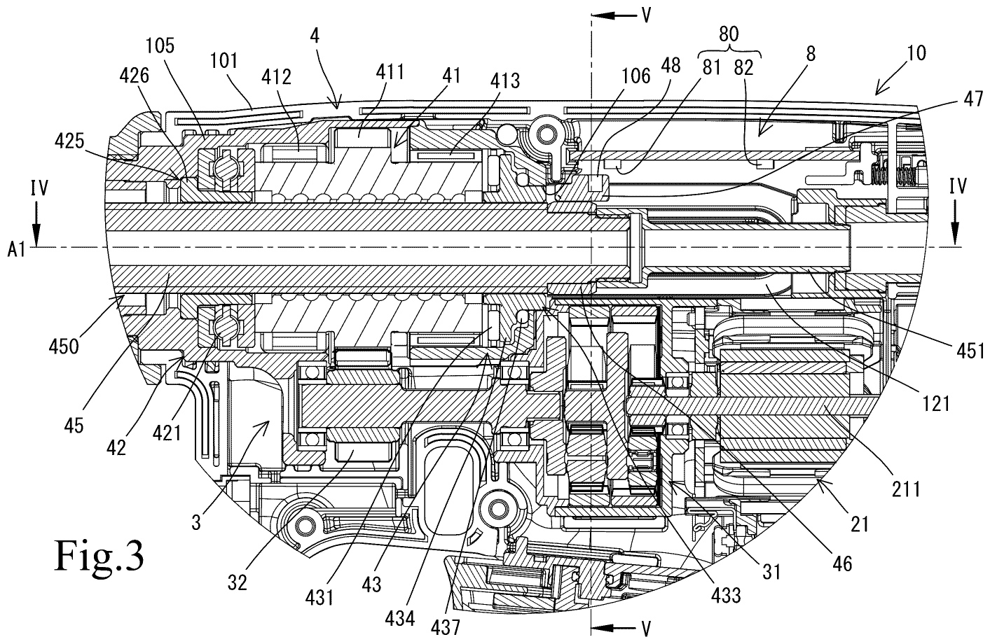

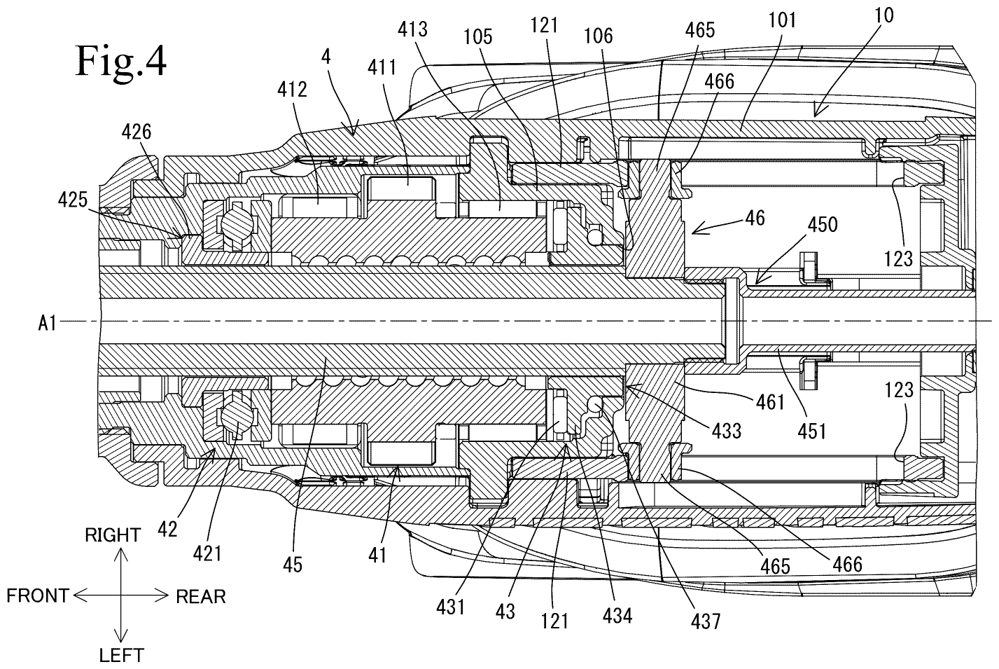

The ball screw mechanism 4 is a motion converting mechanism configured to convert rotation into linear motion. As shown in FIGS. 3 and 4, the ball screw mechanism 4 mainly includes a nut 41 and a screw shaft 45. In this embodiment, the ball screw mechanism 4 is configured to convert rotation of the nut 41 into linear motion of the screw shaft 45 and to linearly move the pin gripping part 165. The ball screw mechanism 4 is housed in an upper half part of the tool body 10.

The nut 41 is supported to be substantially immovable in the front-rear direction and rotatable around the driving axis A1, relative to the tool body 10. In this embodiment, the nut 41 is housed in the inner housing 105. The nut 41 has a hollow cylindrical shape and has a driven gear 411 integrally formed on its outer periphery. The nut 41 is supported by a pair of radial bearings 412, 413 that are supported by the tool body 10 in front of and behind the driven gear 411. The driven gear 411 is engaged with the driving gear 32.

The screw shaft 45 is engaged with the nut 41 so as to be substantially non-rotatable around the driving axis A1 and movable in the front-rear direction along the driving axis A1, relative to the tool body 10. More specifically, the screw shaft 45 has an elongate shape, and is inserted through the nut 41 to extend along the driving axis A1. Although not shown in detail, spiral grooves are respectively formed in an inner peripheral surface of the nut 41 and an outer peripheral surface of the screw shaft 45 and define a spiral track. A number of balls are rollably disposed within the track. The screw shaft 45 is engaged with the nut 41 via these balls.

A rear end part of the screw shaft 45 protrudes rearward from the inner housing 105 through an opening 106 formed through a rear wall part of the inner housing 105 in the front-rear direction. An extension shaft 451 is coaxially connected and fixed to the rear end part of the screw shaft 45 and integrated with the screw shaft 45. The screw shaft 45 and the extension shaft 451 that are integrated with each other are hereinafter also collectively referred to as a “driving shaft 450”.

The driving shaft 450 has a through hole extending therethrough along the driving axis A1. The collecting container 19 is removably attached to the rear end part of the tool body 10 (see FIG. 1). A pintail separated from the fastener 9 is led to the container 115 through the through hole of the driving shaft 450 and collected in the collecting container 115.

As shown in FIGS. 3 to 5, a rotation stopper 46 is integrally connected to the driving shaft 450 so as to be immovable relative to the driving shaft 450. The rotation stopper 46 is fitted onto the periphery of the rear end part of the screw shaft 45, and includes a base part 461 fixed to the screw shaft 45 and a pair of arm parts 465 respectively extending from the base part 461 to the left and right. A bearing 466 is fitted onto an end part of each of the arm parts 465. A pair of left and right guide plates 121 are fixed within the tool body 10. The guide plates 121 each have a guide groove 123 extending in the front-rear direction. The left and right bearings 466 are respectively arranged within the left and right guide grooves 123.

The rotation stopper 46 is engaged with the guide plates 121 via the bearings 466 and thus inhibits the driving shaft 450 from rotating around the driving axis A1 by torque generated when the nut 41 rotates. Thus, when the nut 41 is rotated around the driving axis A1 according to the driving of the motor 21, the driving shaft 450 linearly moves in the front-rear direction relative to the nut 41 and the tool body 10.

A magnet holder 47 for holding a magnet 48 is fixed on an upper end part of the rotation stopper 46. Thus, the magnet holder 47 and the magnet 48 are integrated with the driving shaft 450 via the rotation stopper 46. The magnet holder 47 holds the magnet 48 such that the magnet 48 is exposed upward. The magnet 48 moves in the front-rear direction along a moving axis parallel to the driving axis A1, along with movement of the driving shaft 450 in the front-rear direction along the driving axis A1.

The position detecting mechanism 8 is configured to detect a magnetic field generated by the magnet 48 to detect the position of the driving shaft 450 and thus the position of the pin gripping part 165. As shown in FIG. 3, in this embodiment, the position detecting mechanism 48 includes two magnetic sensors 80 (a first sensor 81 and a second sensor 82) that are arranged apart from each other in the front-rear direction in the vicinity of the moving axis of the magnet 48.

Each of the magnetic sensors 80 is a sensor (a Hall sensor, a Hall effect sensor) configured to detect the presence and intensity of the magnetic field by utilizing the Hall effect. The magnetic sensor 80 is connected to a controller 20 (see FIG. 1) via a wire (not shown) and configured to output a prescribed detection signal to the controller 20 upon detecting the presence of the magnet 48 within a detection range of the magnetic sensor 80. Detection results of the magnetic sensor 80 are used for drive control of the motor 21 and thus for movement control of the pin gripping part 165. The control based on the detection results of the magnetic sensor 80 will be described in detail below.

As shown in FIGS. 3 and 4, a front receiving part 42 and a rear receiving part 43 are respectively provided on the front and rear sides of the nut 41 and configured to receive axial load (thrust load) applied to the nut 41.

The front receiving part 42 includes a thrust bearing 421 that is arranged between a front end of the nut 41 and a front end part of the tool body 10 (specifically, the inner housing 105) in the front-rear direction. The thrust bearing 421 is provided to receive forward reaction force applied to the nut 41 when the driving shaft 450 and the pin gripping part 165 are moved rearward relative to the tool body 10, while allowing rotation of the nut 41.

The thrust bearing 421 is fitted and supported onto a cylindrical sleeve 425. A flange 426 is formed on a front end of the sleeve 425 and protrudes radially outward. The sleeve 425 is fixedly held by the tool body 10 with the flange 426 fitted into the inner housing 105.

The rear receiving part 43 is arranged between a rear end of the nut 41 and a rear end part of the tool body 10 (specifically, the inner housing 105) in the front-rear direction. The rear receiving part 43 includes a thrust bearing 431, an intervening member 433 and an elastic member 437.

The thrust bearing 431 is arranged behind the rear end of the nut 41. The thrust bearing 431 is provided to receive rearward reaction force applied to the nut 41 when the driving shaft 450 and the pin gripping part 165 are moved forward relative to the tool body 10, while allowing rotation of the nut 41.

The intervening member 433 is disposed between the thrust bearing 431 and the rear end part of the tool body 10 (specifically, the inner housing 105) in the front-rear direction. In this embodiment, the intervening member 433 is formed as a cylindrical member having a flange 434 on its central part. The intervening member 433 is arranged within the inner housing 105 with the screw shaft 45 coaxially inserted therethrough. The thrust bearing 431 is fitted onto a cylindrical front end part of the intervening member 433.

The elastic member 437 is disposed between the flange 434 of the intervening member 433 and the rear end part of the tool body 10 (specifically, the inner housing 105) in the front-rear direction. In this embodiment, a rubber O-ring is used as the elastic member 437. The elastic member 437 elastically deforms to allow the nut 41 and the intervening member 433 to slightly move rearward relative to the tool body 10 when a force of moving the nut 41 rearward relative to the tool body 10 is applied to the elastic member 437.

More specifically, the elastic member 437 is disposed between the flange 434 and the rear end part of the inner housing 105 in a preloaded state (slightly compressed state). Thus, the intervening member 433, the thrust bearing 431 and the nut 41 are biased forward relative to the tool body 10 by the elastic member 437. When the driving shaft 450 is stopped, the intervening member 433 is held in a position where a front surface of the flange 434 abuts on the thrust bearing 431 and a rear surface of the flange 434 is slightly apart forward from a front surface of a real wall part of the inner housing 105. The front end of the nut 41 is held in a position to abut on a rear surface of a rear bearing ring of the thrust bearing 421 of the front receiving part 42.

A cylindrical rear end part of the intervening member 433 is slidably arranged in the opening 106 of the rear wall part of the inner housing 105. When the driving shaft 450 is stopped (when rearward force is not substantially applied to the nut 41), a rear end of the intervening member 433 is located at substantially the same position as or slightly forward of a rear end of the opening 106 of the inner housing 105 in the front-rear direction. This position of the intervening member 433 is referred to as a frontmost position of the intervening member 433.

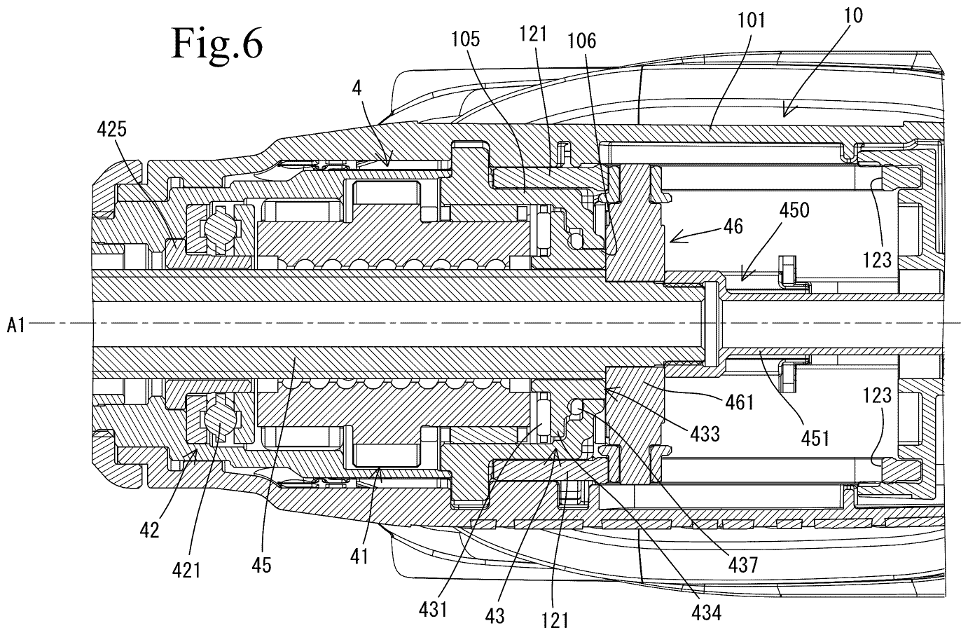

When the driving shaft 450 is moved forward relative to the tool body 10 and rearward reaction force is applied to the nut 41, as shown in FIG. 6, the nut 41, the thrust bearing 431 and the intervening member 433 are slightly moved rearward relative to the tool body 10 while compressing the elastic member 437. Thus, the rear end of the intervening member 433 slightly protrudes rearward from the rear end of the opening 106 of the inner housing 105. This position of the intervening member 433 is referred to as a protruding position of the intervening member 433.

When the driving shaft 450 is moved forward, the rear end of the intervening member 433 in the protruding position abuts on a front surface of the base part 461 of the rotation stopper 46 and thus prevents further forward movement of the driving shaft 450. Specifically, the rotation stopper 46 and the intervening member 433 cooperate to function as a positioning part or a stopper that positions the driving shaft 450 and thus the pin gripping part 165 in the frontmost position relative to the tool body 10.

In this embodiment, the inner housing 105 is formed of aluminum in consideration of weight reduction, while the rotation stopper 46 and the intervening member 433 that abut each other are formed of iron in order to secure strength.

The nose 16 is now described.

As shown in FIG. 2, the nose 16 mainly includes the anvil 161 and the pin gripping part 165. The structures of the anvil 161 and the pin gripping part 165 are known and therefore described in brief.

The anvil 161 has a cylindrical shape as a whole and has a bore 162 extending along the driving axis A1. A front end part of the bore 162 is configured to be engaged with the collar 95 of the fastener 9 (see FIG. 1). The anvil 161 is removably connected to a front end part of the tool body 10 (the inner housing 105) via a connecting member.

The pin gripping part 165 is configured to grip the pin 91 (the shaft part) of the fastener 9 and held to be movable in the front-rear direction along the driving axis A1 relative to the anvil 161. More specifically, the pin gripping part 165 is held coaxially with the anvil 161 within the bore 162 so as to be slidable within the bore 162. The pin gripping part 165 has claws that are configured to grip the shaft part of the pin 91. The pin gripping part 165 is configured such that the gripping force of the claws increases as the pin gripping part 165 moves rearward relative to the anvil 161.

A rear end part of the pin gripping part 165 is connected to a front end part of the screw shaft 45 via a connecting member 166. Thus, the pin gripping part 165 is integrally moved with the screw shaft 45 (the driving shaft 450). The pin gripping part 165 and the connecting member 166 define a passage that extends along the driving axis A1 and communicates with the through hole of the driving shaft 450. A pintail separated from the fastener 9 passes through the inside of the pin gripping part 165, the connecting member 166 and the driving shaft 450 and is collected in the collecting container 19.

A rear end part of the connecting member 166 has a larger diameter than the screw shaft 45 and can be slid in the bore 162 of the anvil 161. The flange 426 of the sleeve 425 fixed to the tool body 10 prevents further rearward movement of the driving shaft 450 by abutting on a rear end of the connecting member 166. Specifically, the sleeve 425 and the connecting member 166 cooperate to function as a positioning part or a stopper that positions the driving shaft 450 and thus the pin gripping part 165 in the rearmost position relative to the tool body 10. The connecting member 166 and the sleeve 425 that abut each other are formed of iron in order to secure strength.

The handle 17 and elements disposed therein are now described.

As shown in FIG. 1, a part other than a lower end part of the handle 17 is configured as a grip part 170 and has a thickness suitable for gripping. The lower end part of the handle 17 has a rectangular box-like shape and houses the controller 20. The lower end part of the handle 17 is hereinafter also referred to as a controller housing part 175.

The trigger 171 is provided in an upper end front part of the handle 17 (the grip part 170). A switch 172 is housed within an upper end part of the grip part 170. The switch 172 is configured to be normally kept off and to be kept on while the trigger 151 is depressed.

The controller 20 is a control device configured to control operation (such as driving of the motor 21) of the fastening tool 1, and includes at least one processor/processing circuit and at least one memory that are mounted on a circuit board. In this embodiment, the controller 20 is configured as a microcomputer including a CPU, a ROM and a RAM. The controller 20 is electrically connected to the magnetic sensor 80 (see FIG. 2) and the switch 172 via wires (not shown).

Movement of the pin gripping part 165 and detection of the position of the pin gripping part 165 by the magnetic sensor 80 (the first and second sensors 81, 82) of the position detecting mechanism 8 are now described. As described above, the driving shaft 450 and the pin gripping part 165 are integrally moved, so that movement of the pin gripping part 165 means movement of the driving shaft 450.

The pin gripping part 165 can be moved between the frontmost position and the rearmost position within a movable range in the front-rear direction as described above, but normally, the pin gripping part 165 is moved between the frontmost position and a rear stop position located forward of the rearmost position.

More specifically, in the forward movement (in the return operation), the pin gripping part 165 is moved forward until the front surface of the base part 461 of the rotation stopper 46 abuts on the rear end of the intervening member 433 located in the protruding position as shown in FIG. 6, and then positioned in the frontmost position. Subsequently, when the motor 21 is stopped and the movement of the pin gripping part 165 is stopped, as shown in FIG. 4, the intervening member 433 is returned to the frontmost position by the biasing force of the elastic member 437. Thus, when the pin gripping part 165 is located in the frontmost position and the motor 21 is stopped, which state is hereinafter referred to as an initial state of the fastening tool 1, the front surface of the base part 461 of the rotation stopper 46 is slightly apart rearward from the rear end of the intervening member 433 and the real wall part of the inner housing 105.

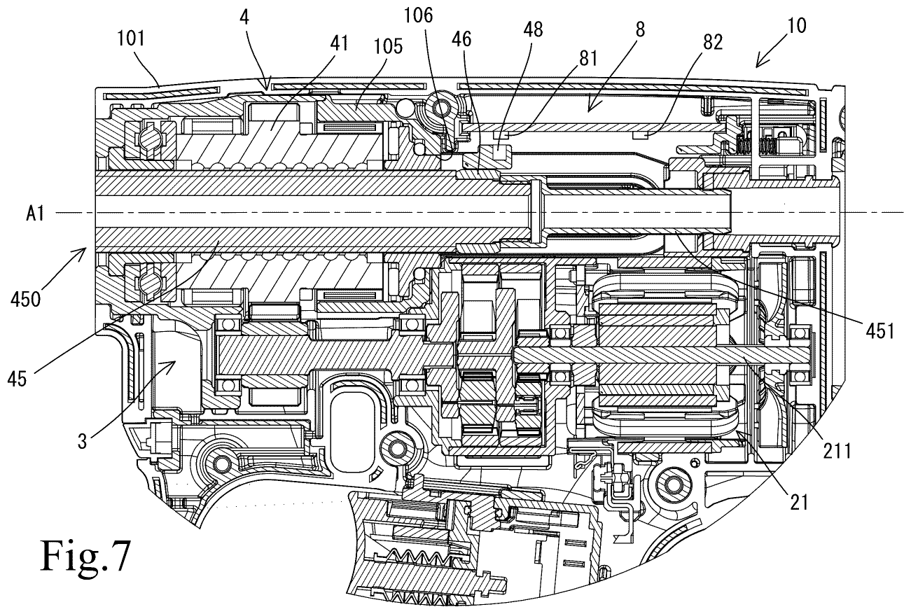

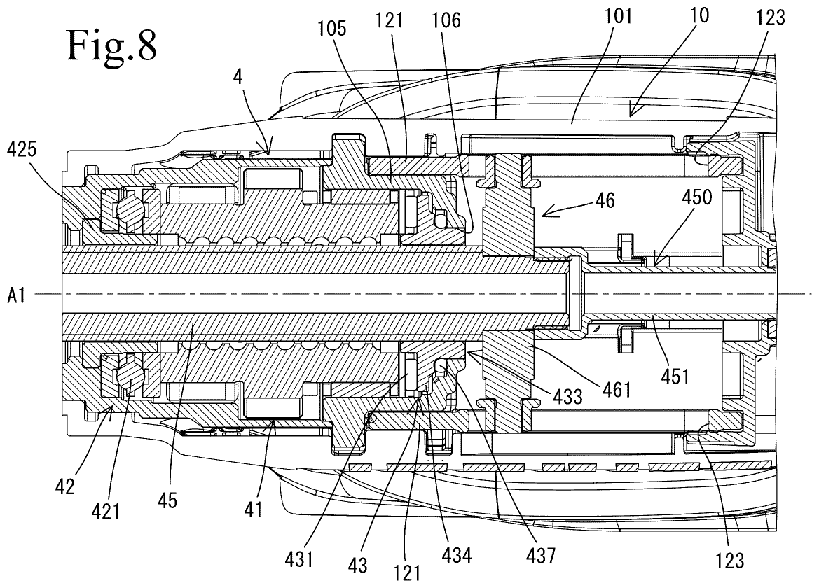

The first sensor 81 of the position detecting mechanism 8 is provided to detect the pin gripping part 165 when the pin gripping part 165 is located in a prescribed position (hereinafter referred to as a first detection position) rearward of the frontmost position. More specifically, the first sensor 81 is arranged in a position to be able to detect the magnet 48 when the pin gripping part 165 reaches the first detection position in the process of moving forward. In this embodiment, as shown in FIG. 7, the magnet 48 is located substantially just below the first sensor 81 when the pin gripping part 165 is located in the first detection position. Further, as shown in FIG. 8, the rotation stopper 46 is located apart rearward from the rear end of the intervening member 433 and the real wall part of the inner housing 105 when the pin gripping part 165 is located in the first detection position.

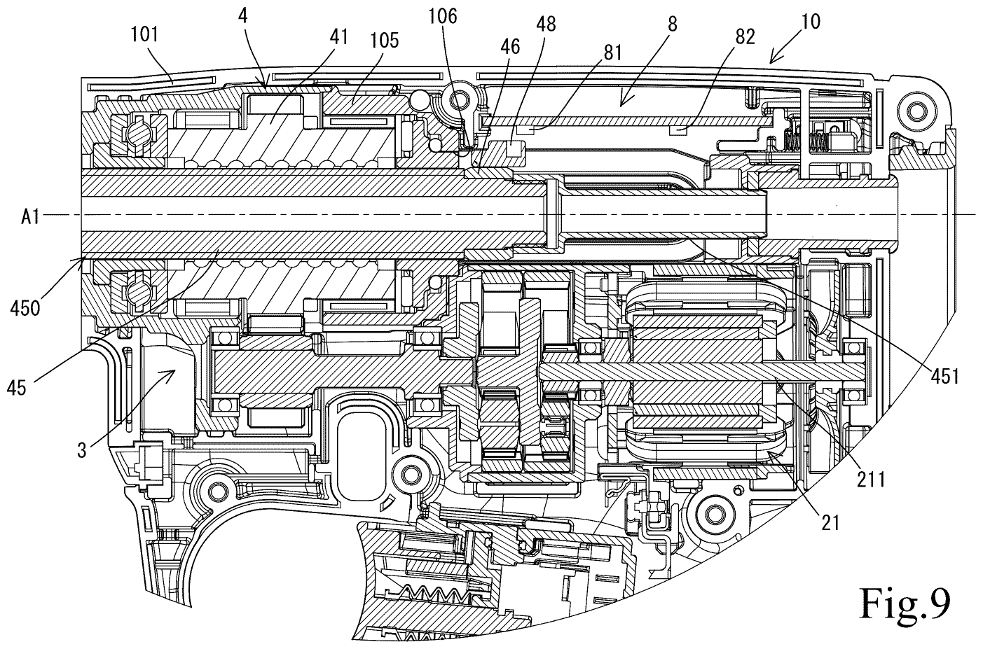

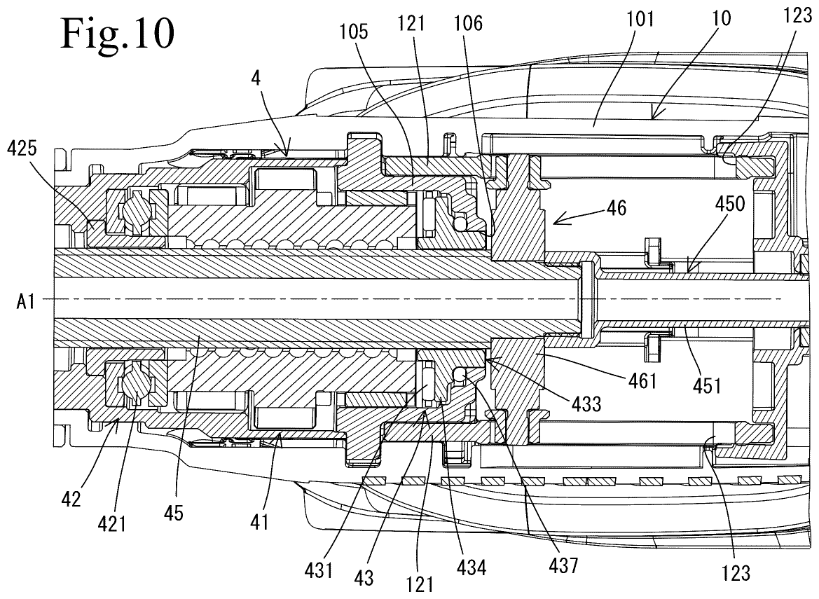

Upon detecting the magnet 48, the first sensor 81 outputs a detection signal to the controller 20. In this embodiment, the controller 20 is configured to, when receiving the detection signal from the first sensor 81 during return operation of the pin gripping part 165, reduce the rotational speed of the motor 21 to a prescribed speed before the pin gripping part 165 reaches the frontmost position, and thereafter maintain the reduced speed. A position where the rotational speed of the motor 21 reaches the prescribed speed is hereinafter referred to as a deceleration completion position. As shown in FIGS. 9 and 10, when the pin gripping part 165 is located in the deceleration completion position, the rotation stopper 46 is located further forward than when the pin gripping part 165 is located in the first detection position, but still located apart from the rear end of the intervening member 433 and the real wall part of the inner housing 105.

In this embodiment, in the rearward movement (in the pulling operation), the pin gripping part 165 is stopped at the rear stop position forward of the rearmost position.

The second sensor 82 is provided to detect the pin gripping part 165 when the pin gripping part 165 is located in a prescribed position (hereinafter referred to as a second detection position) forward of the rearmost position and the rear stop position. More specifically, the second sensor 82 is arranged in a position rearward of the first sensor 81 to be able to detect the magnet 48 when the pin gripping part 165 reaches the second detection position in the process of moving rearward. In this embodiment, although not shown, the magnet 48 is located substantially just below the second sensor 82 when the pin gripping part 165 is located in the second detection position. The second detection position of the pin gripping part 165 is set rearward of a position of the pin gripping part 165 where the pintail of the pin 91 strongly pulled rearward by the pin gripping part 165 is torn off.

In this embodiment, the first and second sensors 81, 82 are mounted on a common circuit board and arranged above the moving axis of the magnet 48 to face the moving axis. The first and second sensors 81, 82 may however be mounted on separate circuit boards, respectively.

Upon detecting the magnet 48, the second sensor 82 outputs a detection signal to the controller 20. In this embodiment, the controller 20 quickly stops the motor 21 when recognizing the detection signal from the second sensor 82 during pulling operation of the pin gripping part 156, which will be described in detail below. The pin gripping part 165 is slightly moved rearward by the time when the motor 21 completely stops after starting to decelerate, and then stopped at the rear stop position.

The second sensor 82 may not be able to detect that the pin gripping part 165 reaches the second detection position during pulling operation, due to some failures or malfunctions. Even in such an event, the pin gripping part 165 is prevented from moving rearward of the rearmost position by abutment between the connecting member 166 and the sleeve 425.

Next, the electrical structure of the fastening tool 1 is described.

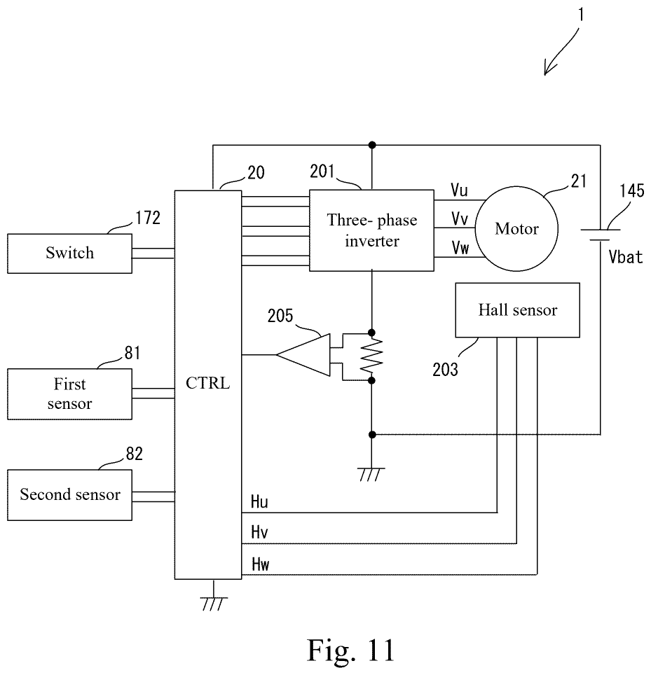

As shown in FIG. 11, a three-phase inverter 201 and a Hall sensor 203 are electrically connected to the controller 20 of the fastening tool 1. The three-phase inverter 201 has a three-phase bridge circuit using six semiconductor switching elements. The three-phase inverter 201 actuates the switching elements of the three-phase bridge circuit according to a duty ratio indicated by a control signal from the controller 20. The Hall sensor 203 has three Hall elements arranged corresponding to respective phases of the motor 21, and is configured to output a signal indicating a rotation angle (rotational position) of the rotor (the motor shaft 211) of the motor 21 to the controller 20.

A current detecting amplifier 205 is electrically connected to the controller 20. The current detecting amplifier 205 converts the driving current of the motor 21 to a voltage by a shunt resistor and outputs a signal amplified by the amplifier to the controller 20.

Further, the switch 172 of the trigger 171 and the first and second sensors 81, 82 are electrically connected to the controller 20. In this embodiment, the controller 20 is configured to control the rotational speed of the motor 21 by PWM control. The controller 20 appropriately controls driving of the motor 21 based on signals outputted from the switch 172, the first and second sensors 81, 82 and the current detecting amplifier 205 to control operation of the driving mechanism 3 and thus movement of the pin gripping part 165.

Next, control processing of the motor 21 in the fastening tool 1 is described.

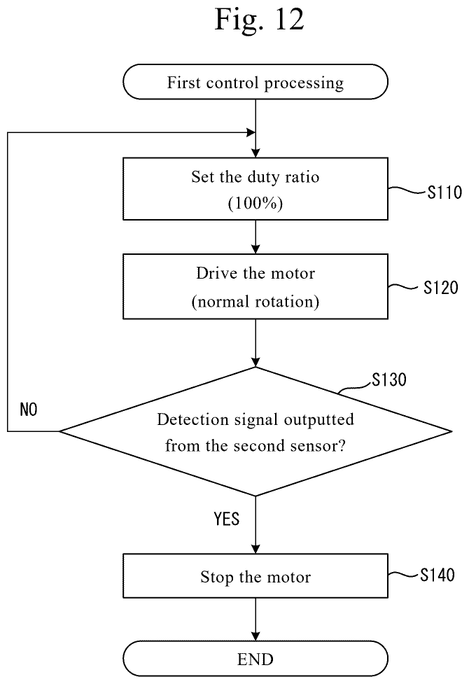

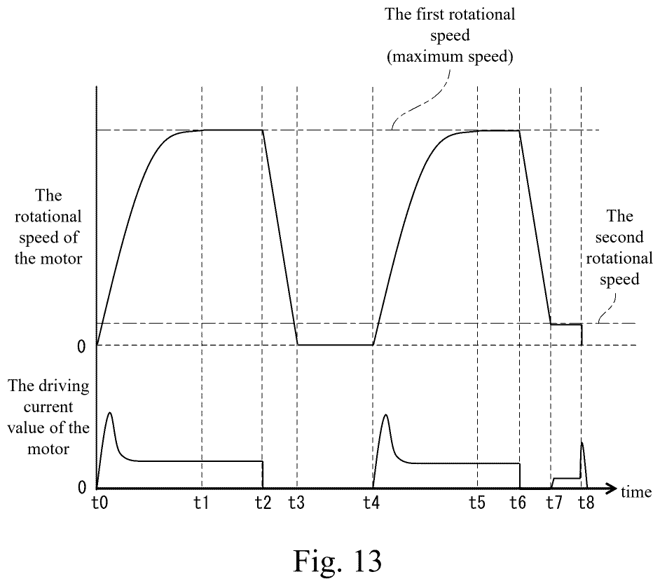

First, control processing of the motor 21 in pulling operation of the pin gripping part 165 (hereinafter referred to as first control processing) is described with reference to FIGS. 12 and 13. The first control processing is started when the trigger 171 is depressed by a user and the switch 172 is turned on. The controller 20 (specifically, the CPU) executes the first control processing by reading out and executing programs stored in the memory (such as the ROM). In the following description and the attached flowchart, “step” is abbreviated as “S”.

At the time (time t0 in FIG. 13) when the first control processing is started, the pin gripping part 165 is located in the frontmost position (see FIGS. 3 and 4). As shown in FIG. 12, when the first control processing is started, the controller 20 sets the duty ratio for PWM control to drive the motor 21 at a prescribed rotational speed. In this embodiment, the rotational speed in pulling operation is set to the maximum speed of the motor 21 in consideration of the efficiency of the fastening operation, and the duty ratio is set to 100% (S110). In other embodiments, however, the rotational speed in the pulling operation and a corresponding duty ratio may be appropriately changed.

The controller 20 drives the motor 21 at the set duty ratio (S120). In the pulling operation, the motor shaft 211 rotates in the normal direction. The driving mechanism 3 is driven and the pin gripping part 165 gripping the pin 91 of the fastener 9 is moved rearward. The rotational speed of the motor 21 is increased to the maximum speed (in a period from time t0 to time t1) and kept at the maximum speed (in a period from time t1 to time t2).

The controller 20 monitors the detection signal outputted from the second sensor 82 while the motor 21 is driven (while the pin gripping part 165 is moved rearward) (S130). The controller 20 continues to drive the motor 21 at the maximum speed while not recognizing the detection signal from the second sensor 82 (while the pin gripping part 165 does not reach the second detection position) (S130: NO, S110, S120). During this time, the pin gripping part 165 is moved rearward while pulling the pin 91, and the workpieces W are fastened by the fastener 9. As described above, the pintail is torn off before the pin gripping part 165 reaches the second detection position.

When the pin gripping part 165 reaches the second detection position and the detection signal is outputted from the second sensor 82, the controller 20 stops the motor 21 (rotation of the motor shaft 211) (S140), and completes the first control processing. In S140, the motor 21 may be stopped, for example, only by stopping energization to the motor 21. Alternatively, in order to quickly stop the motor 21, the motor 21 may be braked. In this embodiment, the controller 20 generates a maximum braking force by short-circuiting terminals of all of the three phases of the motor 21 in order to stop the motor 21 in the shortest time (in a period from time t2 to time t3). When the motor 21 completely stops rotating (at time t3) and the pin gripping part 165 is stopped at the rear stop position, the pulling operation of the pin gripping part 165 is completed.

In this embodiment, although not shown as a step of the processing in the flowchart, when the trigger 171 is released during the first control processing and the switch 172 is turned off, the controller 20 shifts the processing to S140 to stop the motor 21 and completes the first control processing, and then proceeds to a second control processing described below.

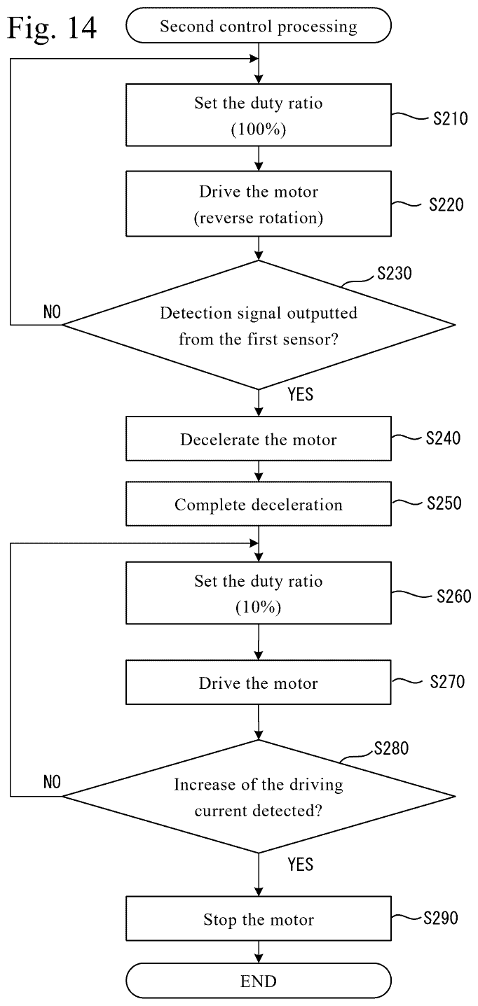

Next, control processing of the motor 21 in return operation of the pin gripping part 165 (hereinafter referred to as second control processing) is described with reference to FIGS. 13 and 14. The second control processing is started when, after completion of the above-described first control processing, the trigger 171 is released by the user and the switch 172 is turned from on to off. Like the first control processing, the controller 20 (specifically, the CPU) executes the second control processing by reading and executing programs stored in the memory (such as the ROM).

As described above, at the time (time t4 in FIG. 13) when the second control processing is started, the pin gripping part 165 is located in the rear stop position. As shown in FIG. 14, when the second control processing is started, the controller 20 sets the duty ratio for PWM control to drive the motor 21 at a prescribed first rotational speed. In this embodiment, the first rotational speed in return operation is set to the maximum speed of the motor 21 in consideration of the efficiency of the fastening operation, and the duty ratio is set to 100% (S210). In other embodiments, however, the first rotational speed and a corresponding duty ratio may be appropriately changed.

The controller 20 drives the motor 21 at the set duty ratio (S220). In the return operation, the motor shaft 211 rotates in the reverse direction. The driving mechanism 3 is driven and the pin gripping part 165 is moved forward. The rotational speed of the motor 21 is increased to the first rotational speed (the maximum speed) (in a period from time t4 to time t5) and kept at the maximum speed (in a period from time t5 to time t6).

The controller 20 monitors the detection signal outputted from the first sensor 81 while the motor 21 is driven (while the pin gripping part 165 is moved forward) (S230). The controller 20 continues to drive the motor 21 at the maximum speed while not recognizing the detection signal from the first sensor 81 (while the pin gripping part 165 does not reach the first detection position) (S230: NO, S210, S220).

When the pin gripping part 165 reaches the first detection position (see FIGS. 7 and 8) and the detection signal is outputted from the first sensor 81 (S230: YES), the controller 20 decelerates the motor 21 (reduces the rotational speed of the motor 21) to a prescribed second rotational speed, which is lower than the first rotational speed (S240).

In this embodiment, as described above, the forward movement of the pin gripping part 165 is completely stopped in the frontmost position by abutment between the intervening member 433 and the rotation stopper 46. Therefore, in order to reduce or suppress impact due to abutment between the intervening member 433 and the rotation stopper 46, it is preferable for the second rotational speed to be less than 20% of the first rotational speed. In this embodiment, the second rotational speed is set to 10% of the first rotational speed or the maximum speed of the motor 21. With this setting, impact in collision between the intervening member 433 and the rotation stopper 46 is effectively reduced or suppressed, while the first rotational speed is set to the maximum speed in consideration of the efficiency of the fastening operation.

In this embodiment, the second rotational speed is set such that stress due to abutment between the intervening member 433 and the rotation stopper 46 does not exceed fatigue limits of the intervening member 433 and the rotation stopper 46. With this setting, the possibility of damage of the intervening member 433 and the rotation stopper 46 is effectively reduced.

In S240, the motor 21 can be decelerated, for example, by generating a braking force by short-circuiting terminals of at least two of the three phases of the motor 21 (by so-called short-circuit braking). The magnitude of the braking force can be adjusted by changing the number of the phases to be short-circuited and/or the short-circuiting time. In this embodiment, the position of the first sensor 81 (the distance between the first detection position and the deceleration completion position) and the braking force applied to the motor 21 are set to ensure that the rotational speed of the motor 21 reaches the second rotational speed when the pin gripping part 165 reaches the deceleration completion position (see FIGS. 9 and 10). The deceleration completion position of the pin gripping part 165 is set at a prescribed distance rearward from the frontmost position (see FIG. 6).

In this embodiment, in S240, the controller 20 generates the maximum braking force by short-circuiting terminals of all of the three phases of the motor 21 to decelerate the motor 21 to the second rotational speed in the shortest period of time (in the shortest distance) (in a period from time t6 to time t7). Thus, the motor 21 is driven at the first rotational speed (the maximum speed) for the longest period of time in the return operation, so that the efficiency of the fastening operation is optimized.

In other embodiments, the motor 21 can be decelerated in S240, for example, by reducing the duty ratio for PWM control. The controller 20 may change the duty ratio such that the rotational speed of the motor 21 is reduced at a constant rate of change (linearly). Alternatively, the controller 20 may change the duty ratio such that it is reduced quadratically or exponentially (non-linearly).

The controller 20 stands by until the actual rotational speed of the motor 21 that is specified based on a signal from the Hall sensor 203 is reduced to the second rotational speed (S250). When the actual rotational speed of the motor 21 reaches the second rotational speed (at time t7), the controller 20 sets the duty ratio to 10% (S260) and continues to drive the motor 21 at the second rotational speed (S270) (in a period from time t7 to time t8).

The controller 20 determines whether the rotation stopper 46 and the intervening member 433 abut each other (whether the pin gripping part 165 reaches the frontmost position (S280). Abutment between the intervening member 433 and the rotation stopper 46 can be detected, for example, by detecting a physical quantity relating to the driving state of the motor 21. Specifically, when the forward movement of the pin gripping part 165 is prevented by abutment between the intervening member 433 and the rotation stopper 46, the driving current value of the motor 21 is rapidly increased and the rotational speed of the motor 21 is rapidly reduced. Therefore, the driving current value of the motor 21 and the rotational speed of the motor 21 are suitable as physical quantities for determining whether the rotation stopper 46 and the intervening member 433 abut each other.

In this embodiment, the rate of change of the driving current value of the motor 21 is used to detect abutment between the intervening member 433 and the rotation stopper 46. More specifically, the controller 20 determines whether the increase rate of the driving current value of the motor 21 exceeds a prescribed increase rate, based on a signal outputted from the current detecting amplifier 205. The controller 20 continues to drive the motor 21 at the second rotational speed while the increase rate of the driving current value of the motor 21 does not exceed the prescribed increase rate (S280: NO, S260, S270).

In other embodiments, it may be determined whether the driving current value exceeds a prescribed threshold, or whether the rotational speed of the motor 21 is reduced below a prescribed threshold, or whether the reduction rate of the rotational speed of the motor 21 is reduced below a prescribed reduction rate.

When determining that the rotation stopper 46 and the intervening member 433 abut each other and the increase rate of the driving current value of the motor 21 exceeds the prescribed increase rate (S280: YES) (at time t8 in FIG. 13), the controller 20 stops the motor 21 (S290) and completes the second control processing. Like in S140 of the first control processing, the motor 21 may be stopped only by stopping energization to the motor 21, or the motor 21 may be braked. The intervening member 433 is returned from the protruding position to the frontmost position while the pin gripping part 165 is positioned in the frontmost position, and the return operation of the pin gripping part 165 is completed.

In this embodiment, as described above, when the pin gripping part 165 is moved forward back to the frontmost position, the rotation stopper 46 and the intervening member 433 abut each other and the pin gripping part 165 is positioned in the frontmost position, and the controller 20 stops the motor 21. Thus, the motor 21 is stopped while the pin gripping part 165 is physically prevented from moving forward in the frontmost position. Therefore, the pin gripping part 165 is reliably returned to the prescribed frontmost position.

In the process of the forward movement of the pin gripping part 165, the controller 20 decelerates the motor 21 and thus the pin gripping part 165 when the first sensor 81 detects that the pin gripping part 165 reaches the first detection position rearward of the frontmost position. The deceleration of the motor 21 and the pin gripping part 165 is completed before the pin gripping part 165 reaches the frontmost position. Thus, the rotation stopper 46 abuts on the intervening member 433 while moving at the second rotational speed after deceleration. Therefore, impact in collision between the intervening member 433 and the rotation stopper 46 is effectively reduced or suppressed.

### Second Embodiment

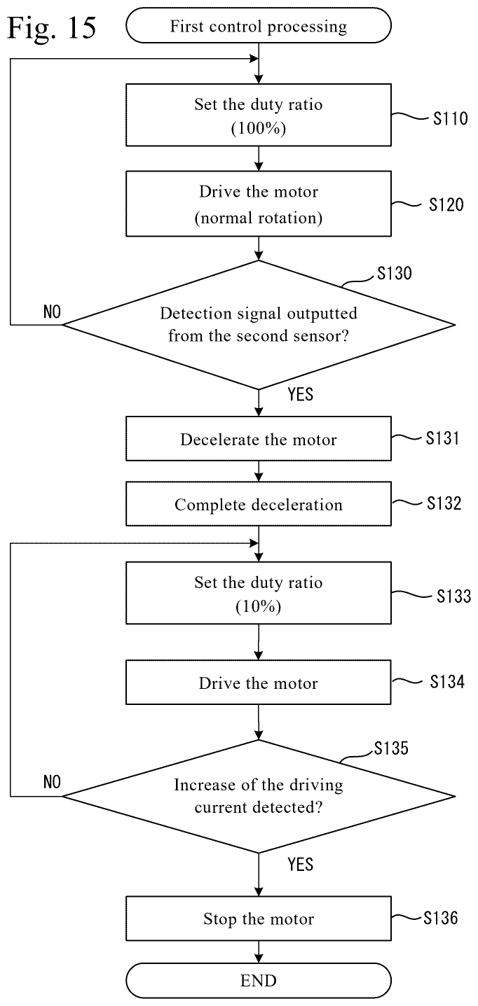

A second embodiment of the present disclosure is now described with reference to FIG. 15. In the second embodiment, the first control processing of the motor 21 that is executed by the controller 20 is different in part from that of the first embodiment, but the contents of the other processing and the structure of the fastening tool 1 are substantially identical to those of the first embodiment. Therefore, in the following description, substantially the same process steps as in the first embodiment are given the same step numerals and their description is omitted or simplified, and only the different processing contents are described.

In the first control processing of this embodiment, the same process steps as in the second control processing of the first embodiment are performed. Briefly, the controller 20 decelerates the motor 21 from the first rotational speed to the second rotational speed when it is detected that the pin gripping part 165 reaches the second detection position. Thereafter, when it is detected that the pin gripping part 165 reaches the rearmost position and the sleeve 425 and the connecting member 166 (see FIG. 2) abut each other, the controller 20 stops the motor 21.

More specifically, as shown in FIG. 15, when the first control processing is started, the controller 20 sets the duty ratio (100%) corresponding to the prescribed first rotational speed (the maximum speed) in pulling operation (S110). The controller 20 drives the motor 21 at the set duty ratio (S120). The controller 20 continues to drive the motor 21 at the maximum speed while not recognizing the detection signal from the second sensor 82 (while the pin gripping part 165 does not reach the second detection position) (S130: NO, S110, S120).

When the pin gripping part 165 reaches the second detection position and the detection signal is outputted from the second sensor 82, the controller 20 decelerates the motor 21 (reduces the rotational speed of the motor 21) (S131). In this embodiment, the movement of the pin gripping part 165 is completely stopped by abutment between the sleeve 425 and the connecting member 166. Therefore, like the second rotational speed of the first embodiment, the second rotational speed of this embodiment is preferred to be 20% or less of the first rotational speed (the maximum speed) at the start of pulling operation in order to reduce or suppress impact due to abutment between the sleeve 425 and the connecting member 166. In this embodiment, the reduced rotational speed is set to 10% of the maximum speed of the motor 21.

A decelerating method in S131 may be the same as the decelerating method in S240 of the second control processing of the first embodiment. For example, the controller 20 generates a maximum braking force by short-circuiting terminals of all of the three phases of the motor 21 so as to obtain the second rotational speed at the deceleration completion position between the second detection position and the rearmost position, and thereby decelerates the motor 21 in the shortest period of time (in the shortest distance). In other embodiments, however, the decelerating method in the process of the rearward movement of the pin gripping part 165 may be different from the decelerating method in the process of the forward movement of the pin gripping part 165.

The controller 20 stands by until the actual rotational speed of the motor 21 is reduced to the second rotational speed (S132). When the actual rotational speed of the motor 21 reaches the second rotational speed, the controller 20 sets the duty ratio to 10% (S133) and continues to drive the motor 21 at the second rotational speed (S134).

The controller 20 determines whether the sleeve 425 and the connecting member 166 abut each other (whether the pin gripping part 165 reaches the rearmost position). Abutment between the sleeve 425 and the connecting member 166 can be detected in the same way as abutment between the intervening member 433 and the rotation stopper 46. Specifically, the controller 20 determines whether the sleeve 425 and the connecting member 166 abut each other according to whether the increase rate of the driving current value of the motor 21 exceeds a prescribed increase rate (S135). The controller 20 continues to drive the motor 21 at the second rotational speed while the increase rate of the driving current value of the motor 21 does not exceed the prescribed increase rate (S135: NO, S133, S134).

When determining that the sleeve 425 and the connecting member 166 abut each other and the increase rate of the driving current value of the motor 21 exceeds the prescribed increase rate (S135: YES), the controller 20 stops the motor 21 (S136) and completes the first control processing. Like in S290 of the second control processing, the motor 21 may be stopped only by stopping energization to the motor 21, or the motor 21 may be braked. The pulling operation of the pin gripping part 165 is completed, while the pin gripping part 165 is positioned in the rearmost position.

In this embodiment, as described above, even when the pin gripping part 165 is moved rearward, the fastening tool 1 operates similarly as when the pin gripping part 165 is moved forward. Specifically, the fastening operation is performed while the pin gripping part 165 is moved rearward, and when the pin gripping part 165 reaches the rearmost position, the sleeve 425 and the connecting member 166 abut each other, and the pin gripping part 165 is positioned in the rearmost position, and the controller 20 stops the motor 21. Therefore, the pin gripping part 165 is reliably positioned in the rearmost position.

In the process of the rearward movement of the pin gripping part 165, the controller 20 decelerates the motor 21 and thus the pin gripping part 165 when the second sensor 82 detects that the pin gripping part 165 reaches the second detection position forward of the rearmost position. The deceleration of the motor 21 and the pin gripping part 165 is completed before the pin gripping part 165 reaches the rearmost position. Thus, the connecting member 166 collides with the sleeve 425 while moving at the second rotational speed after deceleration. Therefore, impact in collision between the connecting member 166 and the sleeve 425 is effectively reduced or suppressed.

Correspondences between the component elements (features) of the above-described embodiments and the component elements (features) of the present disclosure are as follows. However, the component elements (features) of the above-described embodiments are merely exemplary and do not limit the component elements (features) of the present disclosure or invention.

The first sensor 81 is an example of the “first detecting device”. The base part 461 of the rotation stopper 46 is an example of the “first abutment part”. The rear end part of the intervening member 433 is an example of the “second abutment part”. The current detecting amplifier 205 is an example of the “second detecting device”. The controller 20 (specifically, the CPU) is an example of the “control device”. The ball screw mechanism 4 is an example of the “screw feeding mechanism”. The nut 41, the screw shaft 45 and the rotation stopper 46 are examples of the “nut member”, the “shaft member” and the “rotation stopping part”, respectively. The rear receiving part 43 is an example of the “reaction force receiving part”. The second sensor 82 is an example of the “third detecting device”. The rear end part of the connecting member 166 is an example of the “third abutment part”. The flange 426 of the sleeve 425 is an example of the “fourth abutment part”.

The fastening tool according to the present disclosure is not limited to the fastening tool 1 of the above-described embodiments. For example, the following non-limiting modifications may be made. At least one of these modifications can be employed in combination with at least one of the technical features of the fastening tool 1 of the embodiments and the claimed disclosure.

First, a modification of the structure for positioning the pin gripping part 165 in the frontmost position and the rearmost position is described.

The first and second abutment parts, which abut each other when the pin gripping part 165 reaches the frontmost position from the rear, are not limited to the rotation stopper 46 and the intervening member 433. The first abutment part may be a part of the pin gripping part 165, or may be provided on a member (such as the extension shaft 451) connected to the pin gripping part 165, insofar as it can be moved integrally with the pin gripping part 165 in the front-rear direction. The second abutment part may just be provided within the tool body 10 and configured to position the pin gripping part 165 in the frontmost position by abutting on the first abutment part. Therefore, the second abutment part may be a part (such as the rear wall part of the inner housing 105) of the tool body 10, or may be provided on a member connected to the tool body 10. Although, in the above-described embodiments, the intervening member 433 corresponding to the second abutment part is allowed to slightly move in the front-rear direction relative to the tool body 10, the second abutment part may be immovable in the front-rear direction relative to the tool body 10.

The third and fourth abutment parts configured to position the pin gripping part 165 in the rearmost position are not limited to the connecting member 166 and the sleeve 425, but may be modified similarly to the first and second abutment parts.

Next, a modification of control of the motor 21 according to the structure of the position detecting mechanism 8 (the first and second sensors 81, 82) and the position of the pin gripping part 165 is described.

For example, the magnet 48 may be mounted in any position insofar as it can be moved integrally with the pin gripping part 165 in the front-rear direction. The positions of the first and second sensors 81, 82 can be appropriately changed according to the position of the magnet 48. The first and second sensors 481, 482 may not be the magnetic sensor 80, but instead, may be sensors of the other type (e.g., an optical sensor such as a photo interrupter) or mechanical switches.

The detection that the pin gripping part 165 reaches the first detection position may be made, for example, by using the number of revolutions of the motor 21. More specifically, the controller 20 counts the number of revolutions of the motor 21 based on a signal from the Hall sensor 203 after the pin gripping part 165 starts moving rearward from the frontmost position (after start of driving of the motor 21). When the pin gripping part 165 is moved forward, the controller 20 counts the number of revolutions (rotations) after start of the forward movement and compares the counted number with that counted during the rearward movement. The controller 20 can determine that the pin gripping part 165 reaches the first detection position when a difference between the number of revolutions (rotations) after start of the forward movement and the number of revolutions (rotations) during the rearward movement reaches a prescribed number. Further, the controller 20 can determine that the pin gripping part 165 reaches the second detection position when the number of revolutions (rotations) after start of the rearward movement reaches a prescribed number.

In the above-described embodiments, in the second control processing for moving the pin gripping part 165 forward to the frontmost position, the controller 20 completes deceleration of the pin gripping part 165 at the deceleration completion position (before the intervening member 433 and the rotation stopper 46 abut each other) rearward of the frontmost position. The controller 20 may however control the motor 21 such that the rotational speed of the motor 21 reaches the second rotational speed when the pin gripping part 165 reaches the frontmost position after the first sensor 81 detects that the pin gripping part 165 reaches the first detection position. Specifically, the controller 20 may continue to decelerate the motor 21 while the pin gripping part 165 is moved from the first detection position to the frontmost position. The same applies to the control during movement of the pin gripping part 165 from the second detection position to the rearmost position in the second embodiment.

Other modifications are as follows.

The fastening tool 1 may be configured to fasten the workpieces W by using a fastener of a different type from the fastener 9 of the above-described embodiments (such as a blind rivet and a shaft-retaining type of multi-piece swage type fastener). The fastening tool 1 may be used with plural kinds of fasteners by replacing the anvil 61 and the pin gripping part 165. The shapes and component elements of the tool body 10, the nose 16 (the anvil 161, the pin gripping part 165) and the handle 17 and their connections can be freely changed.

The motor 21 may be a motor other than a three-phase brushless DC motor (such as a DC motor with a brush and an AC motor). The fastening tool 1 may be configured to be operated by electric power supplied not from the battery 145 but from an external AC power source.

The driving mechanism 3 may just be driven by power of the motor 21 to move the pin gripping part 165 in the front-rear direction relative to the anvil 161, and component elements of the driving mechanism 3 and their arrangement can be freely changed. For example, a screw feeding mechanism having a nut and a screw shaft that directly engage with each other may be employed in place of the ball screw mechanism 4. Power may be transmitted from the motor 21 to the ball screw mechanism 4 through a gear train different from the above-described embodiments.

The controller 120 for controlling driving of the motor 21 may be formed not by a microcomputer, but may be formed by a programmable logic device such as an ASIC (Application Specific Integrated Circuit) and an FPGA (Field Programmable Gate Array). The above-described control processing may be distributed to a plurality of processors/processing circuits and executed.

Further, in view of the nature of the present disclosure and the above-described embodiments and their modifications, the following features are provided. At least one of the following features can be employed in combination with at least one of the above-described embodiments, their modifications and the claimed invention.

(Aspect 1) The control device is configured to reduce the rotational speed of the motor to a prescribed speed when the third detecting device detects that the pin gripping part reaches the second detection position, and to thereafter drive the motor at the prescribed speed until the second detecting device detects abutment between the third abutment part and the fourth abutment part.
(Aspect 2) The third detecting device is a magnetic sensor.
(Aspect 3) The rotational speed before deceleration is a maximum rotational speed of the motor, and the rotational speed after deceleration is 15% or less of the rotational speed before deceleration.
(Aspect 4) The reaction force receiving part includes: a receiving member that is arranged rearward of the nut member and supported by the tool body to be movable in the front-rear direction; and an elastic member that is arranged between the receiving member and the tool body in the front-rear direction and biases the receiving member forward relative to the tool body,
the receiving member is normally held in a first position by biasing force of the elastic member, and configured to be moved rearward to a second position relative to the tool body by receiving the rearward reaction force applied to the nut member, and
the second abutment part is a rear end part of the receiving member and abuts on the first abutment part when the receiving member is located in the second position.

The intervening member 433 is an example of the “receiving member” of this aspect, and the elastic member 437 is an example of the “elastic member” of this aspect.

### DESCRIPTION OF THE NUMERALS

1: fastening tool, 10: tool body, 101: outer housing, 105: inner housing, 106: opening, 121: guide plate, 123: guide groove, 145: battery, 16: nose, 161: anvil, 162: bore, 165: pin gripping part, 166: connecting member, 17: handle, 170: grip part, 171: trigger, 172: switch, 175: controller housing part, 19: collecting container, 20: controller, 201: three-phase inverter, 203: Hall sensor, 205: current detecting amplifier, 21: motor, 211: motor shaft, 3: driving mechanism, 31: planetary reduction gear, 32: driving gear, 4: ball screw mechanism, 41: nut, 411: driven gear, 412: radial bearing, 413: radial bearing, 42: front receiving part, 421: thrust bearing, 425: sleeve, 426: flange, 43: rear receiving part, 431: thrust bearing, 433: intervening member, 434: flange, 437: elastic member, 45: screw shaft, 450: driving shaft, 451: extension shaft, 46: rotation stopper, 461: base part, 465: arm part, 466: bearing, 47: magnet holder, 48: magnet, 8: position detecting mechanism, 80: magnetic sensor, 81: first sensor, 82: second sensor, 9: fastener, 91: pin, 95: collar, A1: driving axis, W: workpiece

1. A fastening tool that is configured to fasten workpieces via a fastener having a pin and a cylindrical part, comprising:
a tool body;
a motor that is housed in the tool body;
a pin gripping part that is configured to grip the pin, the pin gripping part being operably connected to the motor and configured to be moved relative to the tool body between a frontmost position and a rearmost position along a driving axis that defines a front-rear direction of the fastening tool, by power of the motor;
a first detecting device that is configured to detect that the pin gripping part is located in a first detection position between the frontmost position and the rearmost position in the front-rear direction;
a first abutment part that is configured to move integrally with the pin gripping part relative to the tool body in the front-rear direction;
a second abutment part that is provided within the tool body and configured to position the pin gripping part in the frontmost position by abutting on the first abutment part when the pin gripping part is moved forward to the frontmost position;
a second detecting device that is configured to detect abutment between the first abutment part and the second abutment part; and
a control device that is configured to control driving of the motor;
wherein:
the pin gripping part is configured to fasten the workpieces via the fastener by moving rearward from the frontmost position, and
the control device is configured to decelerate the motor when the first detecting device detects that the pin gripping part reaches the first detection position in a process of moving forward, and to thereafter stop the motor when the second detecting device detects abutment between the first abutment part and the second abutment part.

2. The fastening tool as defined in claim 1, wherein the control device is configured to reduce the rotational speed of the motor to a prescribed speed when the first detecting device detects that the pin gripping part reaches the first detection position, and to thereafter drive the motor at the prescribed speed until the second detecting device detects abutment between the first abutment part and the second abutment part.

3. The fastening tool as defined in claim 1, wherein the second detecting device is configured to detect a physical quantity relating to a driving state of the motor.

4. The fastening tool as defined in claim 3, wherein the second detecting device is configured to detect at least one of (i) a current value of the motor, (ii) change of the current value of the motor, (iii) rotational speed of the motor, and (iv) change of the rotational speed, as the physical quantity.

5. The fastening tool as defined in claim 1, wherein the first detecting device comprises a magnetic sensor.

6. The fastening tool as defined in claim 1, wherein:
the motor comprises a three-phase brushless motor, and
the control device is configured to generate a braking force by short-circuiting terminals of at least two phases of the motor to decelerate the motor.

7. The fastening tool as defined in claim 1, wherein the control device is configured to decelerate the motor by changing a duty ratio for PWM control of the motor.

8. The fastening tool as defined in claim 1, wherein the rotational speed of the motor after deceleration is lower than 20% of the rotational speed before deceleration.

9. The fastening tool as defined in claim 8, wherein the rotational speed after deceleration is set such that stress due to abutment between the first abutment part and the second abutment part does not exceed fatigue limits of the first abutment part and the second abutment part.

10. The fastening tool as defined in claim 1, further comprising:
a screw feeding mechanism that is operably connected to the motor and the pin gripping part;
wherein:
the screw feeding mechanism includes:
a nut member that is supported to be rotatable around the driving axis within the tool body, and configured to be rotationally driven by the power of the motor, and
a shaft member that is operably engaged with the nut member so as to move integrally with the pin gripping part linearly in the front-rear direction when the nut member is rotated,
the shaft member has a rotation stopping part that is configured to inhibit rotation of the shaft member around the driving axis by engaging with the tool body, and
a part of the rotation stopping part comprises the first abutment part.

11. The fastening tool as defined in claim 10, further comprising:
a reaction force receiving part that is arranged between the nut member and the first abutment part in the front-rear direction and configured to receive rearward reaction force applied to the nut member when the shaft member is moved forward,
wherein a part of the reaction force receiving part comprises the second abutment part.

12. The fastening tool as defined in claim 11, wherein:
the reaction force receiving part includes: a receiving member that is arranged rearward of the nut member and supported by the tool body to be movable in the front-rear direction; and an elastic member that is arranged between the receiving member and the tool body in the front-rear direction and biases the receiving member forward relative to the tool body,
the receiving member is normally held in a first position by biasing force of the elastic member, and configured to be moved rearward to a second position relative to the tool body by receiving the rearward reaction force applied to the nut member, and
the second abutment part is a rear end part of the receiving member and abuts on the first abutment part when the receiving member is located in the second position.

13. The fastening tool as defined in claim 1, further comprising:
a third detecting device that is configured to detect that the pin gripping part is located in a second detection position between the first detection position and the rearmost position in the front-rear direction;
a third abutment part that is configured to move integrally with the pin gripping part relative to the tool body in the front-rear direction; and
a fourth abutment part that is provided within the tool body and configured to position the pin gripping part in the rearmost position by abutting on the third abutment part when the pin gripping part is moved rearward to the rearmost position;
wherein:
the second detecting device is further configured to detect abutment between the third abutment part and the fourth abutment part, and
the control device is configured to decelerate the motor when the third detecting device detects that the pin gripping part reaches the second detection position in a process of moving rearward, and to thereafter stop rotation of the motor when the second detecting device detects abutment between the third abutment part and the fourth abutment part.

14. The fastening tool as defined in claim 13, wherein the control device is configured to reduce the rotational speed of the motor to a prescribed speed when the third detecting device detects that the pin gripping part reaches the second detection position, and to thereafter drive the motor at the prescribed speed until the second detecting device detects abutment between the third abutment part and the fourth abutment part.

15. The fastening tool as defined in claim 2, wherein the second detecting device is configured to detect a physical quantity relating to a driving state of the motor.

16. The fastening tool as defined in claim 15, wherein the second detecting device is configured to detect at least one of (i) a current value of the motor, (ii) change of the current value of the motor, (iii) rotational speed of the motor, and (iv) change of the rotational speed, as the physical quantity.
